(19) United States
(12) Patent Application Publication
(10) Pub. No.: US 2025/0103342 A1
(43) Pub. Date: Mar. 27, 2025

(54) METHOD AND APPARATUS FOR ENABLING MIMD-LIKE EXECUTION FLOW ON SIMD PROCESSING ARRAY SYSTEMS

(71) Applicant: Advanced Micro Devices, Inc., Santa Clara, CA (US)

(72) Inventors: Ryan Lynn Swann, Austin, TX (US); Alexander Sean Underwood, Austin, TX (US); Derrick A. Aguren, Austin, TX (US); Karthik Ramu Sangaiah, Bellevue, WA (US); Sumanth Gudaparthi, Santa Clara, CA (US); Rose R. Thompson, Stillwater, OK (US)

(73) Assignee: Advanced Micro Devices, Inc., Santa Clara, CA (US)

(21) Appl. No.: 18/475,918

(22) Filed: Sep. 27, 2023

(51) Int. Cl. G06F 9/38

(52) U.S. Cl. CPC G06F 9/3889; G06F 9/3887

(57) ABSTRACT

A method, apparatus and computer readable medium that use of a lightweight finite state machine (FSM) control flow block to enable limited execution of data-dependent control flow, thereby enhancing the control flow flexibility of array scale SIMD processors. In certain cases, the FSM block contains registers responsible for decoding and managing single global instructions into multiple local instructions that can incorporate data-dependent control flow.

### STATEMENT OF GOVERNMENT INTEREST

This invention was made with U.S. Government support under Contract No. H98230-22-C-0152 awarded by the Department of Defense. The U.S. Government has certain rights in this invention.

### BACKGROUND

A SIMD (Single Instruction, Multiple Data) processor is a type of computer processor that is designed to perform the same operation on multiple data elements simultaneously. It is specialized for parallel processing tasks that involve performing identical operations on multiple sets of data in parallel.

The concept behind SIMD processing is to exploit data-level parallelism, where multiple data elements are processed simultaneously using a single instruction. This allows for the efficient execution of tasks that can be broken down into parallelizable operations, such as multimedia processing, scientific simulations, image and video processing, and vector calculations.

In a SIMD processor, a single instruction is broadcasted to multiple processing units, each capable of performing the same operation on different data elements simultaneously. These processing units are organized into SIMD lanes or vector lanes. Each lane typically operates on a fixed-size vector of data, such as 4, 8, 16, or more elements, depending on the processor architecture.

The SIMD processor's architecture includes specialized SIMD instructions that operate on the entire array of data elements in a single clock cycle. These instructions can perform operations like addition, subtraction, multiplication, division, logical operations, and others. The data elements are stored in registers, which are the primary storage units for SIMD computations.

The benefits of SIMD processors include increased throughput, reduced instruction overhead, and improved performance for tasks that exhibit data-level parallelism. By processing multiple data elements simultaneously, SIMD processors can achieve significant speedup compared to traditional scalar processors, especially for workloads that involve repetitive computations on large sets of data.

SIMD processors excel at tasks that can be parallelized and benefit from applying the same operation to multiple data elements. However, they may not provide the same level of efficiency for tasks with complex branching or data dependencies, where different instructions need to be executed based on conditions or interdependent data.

A MIMD (Multiple Instruction, Multiple Data) processor is a type of computer processor that can execute multiple instructions on multiple data sets concurrently. Unlike SIMD processors, which perform the same operation on multiple data elements simultaneously, MIMD processors allow for the independent execution of different instructions on separate data sets.

In a MIMD architecture, the processor consists of multiple processing units, often referred to as cores or nodes, that can operate independently and execute their own instructions. Each processing unit has its own program counter, registers, and control logic, allowing it to fetch and execute instructions from its own instruction stream.

MIMD processors are well-suited for tasks that require different instructions to be executed on different data sets simultaneously or tasks that exhibit task-level parallelism. Examples of such tasks include running multiple programs concurrently, executing different threads of a program in parallel, or performing independent computations on separate data sets.

MIMD processors can be further classified into two main categories: shared memory and distributed memory architectures.

MIMD processors offer greater flexibility and generality compared to SIMD processors. They can handle a wider range of applications and workloads that require different instructions or data sets to be processed simultaneously. However, managing the parallelism and synchronization between multiple instruction streams and data sets can be more complex, requiring sophisticated programming models and algorithms to effectively utilize the available processing resources.

A finite state machine (FSM) is a mathematical model used to describe the behavior of a system or process that can be in a finite number of distinct states. It is a computational model that transitions from one state to another in response to inputs or events.

The key components of a finite state machine are:
1. States: The distinct conditions or configurations that the system can be in at a given time. Each state represents a particular situation or behavior of the system.
2. Transitions: The rules or conditions that determine how the system moves from one state to another. Transitions are triggered by inputs or events and define the state change behavior of the system.
3. Inputs or Events: The signals or stimuli that cause the system to transition from one state to another. These can be external events, user actions, or internal conditions.
4. Outputs or Actions: The actions or behaviors associated with specific states or transitions. When the system transitions from one state to another, it may produce certain outputs or perform specific actions.

When an input or event occurs, the FSM evaluates the current state and the input to determine the next state. It follows the transition rules specified by the state transition diagram or table and moves to the appropriate next state. The process continues as the FSM receives subsequent inputs or events, resulting in a sequence of state transitions.

Sparse linear algebra is a branch of linear algebra that deals with matrices and linear systems that exhibit sparsity. In a sparse matrix, most of the elements are zero, while only a small fraction of the elements are non-zero. This sparsity property allows for efficient representation, storage, and computation on such matrices.

In contrast to dense matrices, which have a significant number of non-zero elements, sparse matrices arise naturally in various domains, including graph theory, network analysis, computational physics, optimization problems, and many other areas. Analyzing and solving problems involving sparse matrices can be computationally expensive if traditional dense linear algebra techniques are employed. Therefore, specialized algorithms and techniques have been developed to handle sparse matrices more efficiently.

Sparse linear algebra aims to optimize computations involving sparse matrices by taking advantage of their sparsity structure. Some key concepts and techniques used in sparse linear algebra include:
1. Sparse Matrix Representation: Different formats are used to represent sparse matrices in a compact manner. These formats store only the non-zero elements and their corresponding indices, thus reducing storage requirements. Common representations include the Compressed Sparse Row (CSR), Compressed Sparse Column (CSC), and Coordinate List (COO) formats.
2. Sparse Matrix-Vector Multiplication: Multiplying a sparse matrix by a vector is a fundamental operation in many algorithms. Efficient algorithms have been developed to perform sparse matrix-vector multiplication, taking advantage of the sparsity pattern to minimize computational complexity.
3. Sparse Matrix-Matrix Multiplication: Multiplying two sparse matrices is a more complex operation. Various algorithms, such as the Compressed Sparse Row (CSR) algorithm and the Hashing-based algorithm, have been devised to efficiently perform sparse matrix-matrix multiplication.
4. Sparse Linear Systems: Solving linear systems involving sparse matrices is a common task in many applications. Direct and iterative methods are employed to efficiently solve such systems. Direct methods include factorization techniques like LU (Lower-Upper) and Cholesky factorization, while iterative methods like Conjugate Gradient (CG) and Generalized Minimal Residual (GMRES) are often used to approximate solutions with less computational cost.
5. Graph Algorithms: Many graph algorithms, such as breadth-first search, depth-first search, and shortest path algorithms, can be formulated using sparse matrices. Sparse linear algebra techniques play a crucial role in efficiently executing these algorithms on large-scale graphs.

Overall, sparse linear algebra provides efficient methods for handling matrices and linear systems with sparsity patterns, enabling faster computations and reduced memory requirements compared to traditional dense linear algebra techniques.

Aspects of the present disclosure utilize the addition of an FSM to manage data access and movement in a SIMD Array with a single global instruction. Other aspects of the disclosure control flow in a processor such that an architecture may be managed by instruction template registers which will decompose a single global instruction into several local and data-orchestrated instructions to create a MIMD-like execution flow for data-dependent operations while not adding the additional overhead of a full MIMD control flow.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more features of the disclosure can be implemented;

FIG. 2 is a block diagram of the device, illustrating additional details related to the execution of processing tasks on the accelerated processing device of FIG. 1, according to an example;

FIG. 3 depicts an example conventional array scale SIMD machine;

FIG. 4 depicts an example conventional MIMD machine;

FIG. 5 illustrates an example of a Single Global Instruction with a Finite State Machine Convertor in accordance with aspects of the disclosure;

FIG. 6A illustrates an example of an FSM in accordance with aspects of the disclosure;

FIG. 6B illustrates an example of an FSM in accordance with aspects of the disclosure;

FIG. 7 depicts an example of a Finite State Machine for Sparse Linear Algebra in accordance with aspects of the disclosure;

FIG. 8 illustrates an example of a Compressed Sparse Column (CSC) Compressed Matrix 800;

FIG. 9 illustrates a comparison of an example FSM dataflow and non-FSM dataflow;

FIG. 10 depicts an example Finite State Machine for a Sparse Linear Algebra Control Flow in accordance with aspects of the disclosure;

FIG. 11 shows a comparison of the area of a conventional “CU” core, a 4KiB iCache, and the size of the FSM in accordance with aspects of the present disclosure;

FIG. 12 shows a comparison of power consumption between the Finite State Machine in accordance with embodiments of the present disclosure, compute logic, and a 4KiB iCache; and

FIG. 13 shows an example process for implementing aspects of the disclosure.

### DETAILED DESCRIPTION OF THE DRAWINGS

Modern approaches to processing-intensive workloads would benefit from a domain-specific device that can most efficiently process the data provided to it. In a domain-specific architecture, it is important for each core to be small so more cores can be present in the device. However, control logic to manage data-dependent execution may swell the size of cores and thus limit the number of devices that can fit in an array.

For example, in sparse linear algebra workloads, the execution and control flow are dependent on the sparsity of the data. These data-dependent workloads can cause control flow issues for many-core processing arrays which lack the ability to execute conditional or asynchronous control flows on the array.

One example of an architecture that lacks these features is an array scale SIMD architecture in which a single instruction is launched to the entire array to remove the overhead of control logic. In order to solve this problem in these many-core minimal control architectures, this disclosure proposes the addition of a finite state machine to adapt instruction dispatch to data-dependent kernels in each Processing Element of the array.

Some conventional systems attempt to provide each device with its own set of SIMD control logic. However, the overhead of control logic when compared to something simple like embodiments of the present disclosure is high. As a result, the conventional systems increase the size of each processor and, thus the size of the array by a significant amount. An example of this is a GPU, which integrates control logic into every core on the device.

Other conventional systems utilize a MIMD machine which allows different instructions to be routed to each core in an array. The issue with MIMD machines is that the instruction dispatch can become very complicated, especially when considering processing arrays that contain hundreds or thousands of elements. In these instances, the amount of instruction logic required to dispatch a different instruction to each processing element in a several thousand-element arrays becomes astronomical.

For many workloads in domain-specific architectures, it is not necessary to have the granular control and, thus, the overhead of a MIMD system. However, in many kernels, more control is needed than is available in an array-scale SIMD system. Aspects of the present disclosure utilize a midway solution to this problem by adding a small finite state machine to manage data-dependent execution flows. Accordingly, implementations of the present disclosure create a domain-specific constrained MIMD machine that is able to execute different instructions on each processing element in an Array while not requiring the complex overhead and routing instantiated by the utilization of a MIMD model.

Aspects of the present disclosure allow array scale SIMD systems to be more flexible and efficient for kernels that require parallel processing with irregular memory patterns or load imbalance, such as sparse matrix-vector multiplication (SpMV) or sparse generalized matrix-matrix multiplication (SpGEMM), both of which are of growing interest in sparse-machine learning (ML) use-cases.

Sparse matrix-vector multiplication (SpMV) is a computational operation that involves multiplying a sparse matrix with a dense vector. In linear algebra terms, given a sparse matrix A and a dense vector x, the SpMV operation calculates the product y=A*x, where y is the resulting dense vector.

In a sparse matrix, most of the elements are zero, which means they do not contribute to the final result. Storing and manipulating these zero values would be inefficient and waste memory. Therefore, sparse matrices are usually represented in a compressed format that only stores the non-zero elements and their corresponding indices.

By exploiting the sparsity of the matrix and using the compressed representation, SpMV avoids unnecessary computations and memory operations on zero values, making it efficient for sparse matrices. This operation is commonly used in various scientific and engineering applications, such as numerical simulations, graph algorithms, and data analysis.

Sparse generalized matrix-matrix multiplication (SpGEMM) is an algorithmic framework designed for the efficient multiplication of two sparse matrices, allowing for even more optimizations and improved performance compared to the general sparse matrix-matrix multiplication.

In SpPGEMM, the goal is to multiply two sparse matrices A and B to obtain a resulting sparse matrix C. Similar to sparse matrix-matrix multiplication, SPGEMM takes advantage of the sparsity of the matrices to minimize the number of actual multiplications required.

The SpGEMM algorithm is designed to efficiently handle sparse matrices and leverage parallel processing to speed up the multiplication process. It aims to minimize the number of arithmetic operations performed on zero elements, reduce memory requirements, and take advantage of available hardware resources for improved performance.

Aspects of the present disclosure utilize a light-weight finite state machine (FSM) control flow block to allow limited execution of data-dependent control flow, adding control flow flexibility to array scale SIMD processors. In some instances, an FSM block with registers that decode and manage single global instructions into several local instructions that can incorporate data-dependent control flow is utilized. Accordingly, instances of the present disclosure enable a limited MIMD-like execution flow for data-dependent operations without adding the additional overhead of a full MIMD control flow scheme.

In addition, aspects of the present disclosure offer better efficiency for these workloads over a fully flexible general-purpose “MIMD” architecture, while allowing more flexibility than an array scale SIMD architecture

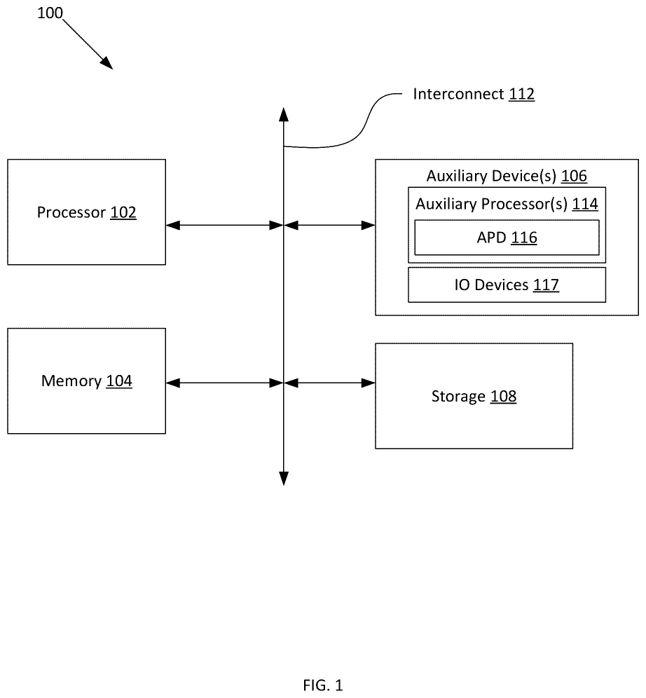

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid-state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm may perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

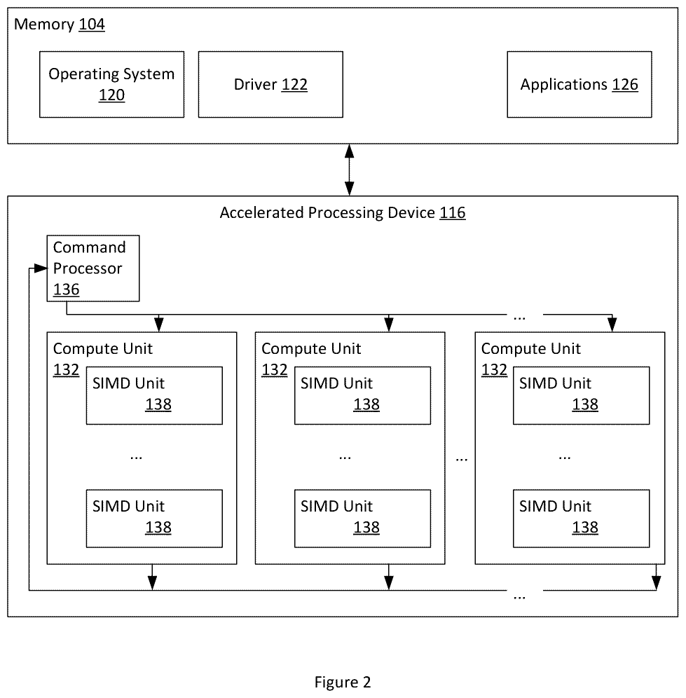

FIG. 2 is a block diagram of the device 100, illustrating additional details related to execution of processing tasks on the APD 116 where aspects of the disclosure can be applied. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some implementations, the driver 122 includes a just-in-time compiler that compiles programs for execution by processing components (such as the SIMD units 138 discussed in further detail below) of the APD 116. In other implementations, no just-in-time compiler is used to compile the programs, and a normal application compiler compiles shader programs for execution on the APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 (together, parallel processing units 202) that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 can have a local L1 cache. In an implementation, multiple compute units 132 share a L2 cache.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group is executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus, in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

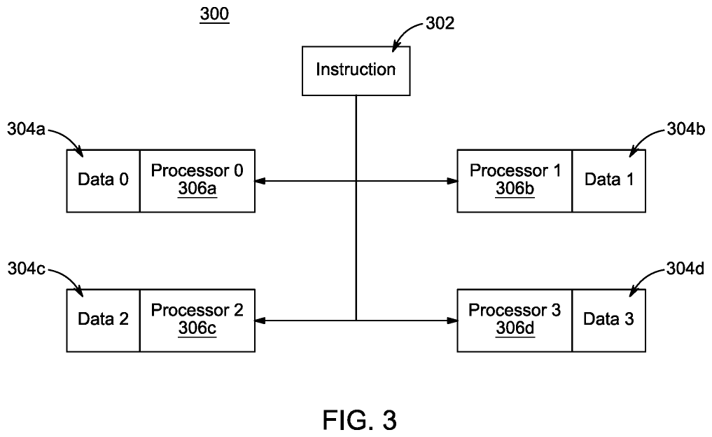

FIG. 3 depicts an example conventional array scale SIMD machine 300. In the example conventional SIMD machine 300, a single instruction 302 is launched to a group of processors 306a-d. In the example conventional array scale SIMD machine 300, every processor 306a-d executes the same instruction 302 in lockstep on the data 304a-d. Accordingly, the example conventional array scale SIMD machine 300 is beneficial for dense, static workloads that do not require any fine-grained data-dependent execution or conditional control flow.

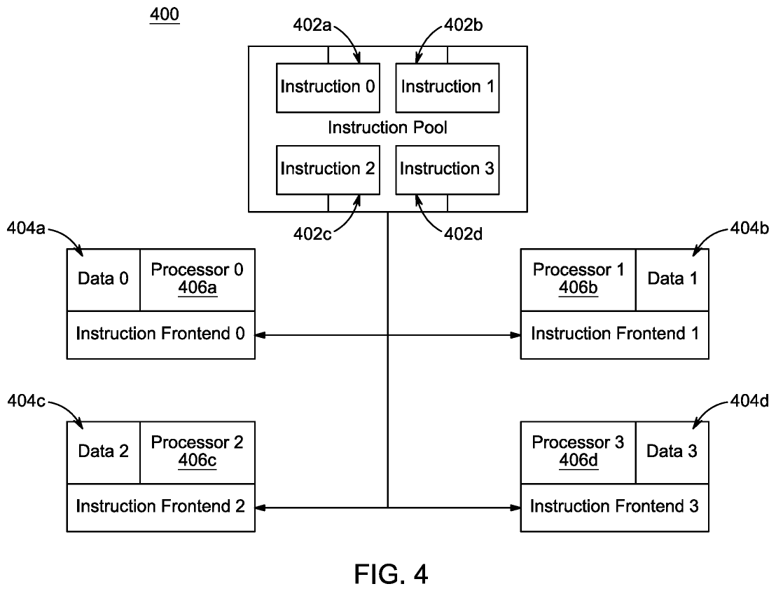

FIG. 4 depicts an example conventional MIMD machine 400. In the example of the conventional MIMD machine 400, a set of different instructions 402a-d is available to all processors 406a-d. In the example of the conventional MIMD machine 400, each processor 406a-d can sequence and execute a different instruction 402a-d at the same time on different data 404a-d. The example conventional MIMD machine 400 is useful in cases where each processor must be able to execute asynchronously on different workloads or datasets. For example, in the example conventional MIMD machine 400, sets of processors 406-d may fetch, decode, and execute instructions 402a-d and data 404a-d separately, thus achieving high levels of parallelism but requiring a significant amount of additional control logic overhead. By contrast, with a SIMD processor, multiple cores must execute the same instruction at the same time. As explained, this provides speed without the cost of the die area needed for additional instruction control flow, but at the cost of the flexibility for each core.

For many data-independent workloads with static control flows, it is not necessary to have the granular control and thus control flow overhead of a MIMD system, as illustrated in FIG. 4. However, in many kernels, more data-dependent control is needed than is available in an array scale SIMD system, as illustrated in FIG. 3.

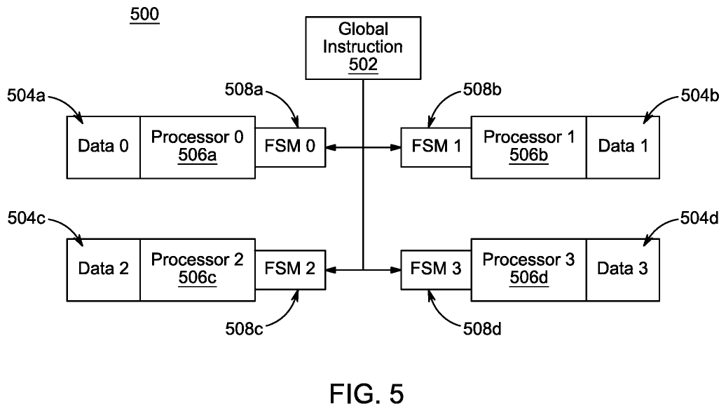

FIG. 5 illustrates an example in accordance with aspects of the disclosure. The single global instruction with finite state machine processor 500 includes finite state machines 508a-d with a SIMD machine 300. The inclusion of the finite state machines 508a-d allows the global instruction with finite state machine processor 500 to manage the execution of the processing of data 504a-504d, stored within the memories of the individual processors 506a-d, by processors 506a-d. For example, in some instances, the single global instruction with finite state machine processor 500 provides the ability to have limited data-dependent divergent control flow while still maintaining a SIMD architecture. Specifically, the processors must execute the same global instruction at any given time (or must be switched off by predication). However, for global instructions that are compatible with data-dependent control flow, the finite state machines 508 control which sub-operation is performed by any given processor 506, in a data-dependent way. Put differently, the processor allows multiple processors 506 to execute the “same instruction” (i.e., the global instruction), in accord with the SIMD paradigm, while also allowing the specific operations performed by such processors 506 to vary in a data-dependent way, in order to complete the overall workflow specified by the global instruction. Global instruction that permit such data-dependent control flow can be thought of as specifying an overall high-level operation whose specific performance is controlled by the finite state machines 508.

In some instances, the finite state machines 508a-d operates in response to “hints” from the global instruction 502. In some instances, a “hint” is provided by a compiler or other entity with the global instruction. The finite state machines 508a-d applies this hint to the control flow of a thread. A thread is the smallest unit of execution within a process. In an example, in response to the hint, each processor 504a-d runs a different step of an algorithm associated with a particular global instruction. For example, in response to the hint, processors 506a, 506b, and 506c operate synchronously (e.g., with the same step of the algorithm) while processor 506d operates asynchronously (e.g., with a different step of the algorithm). This decreases the amount of overhead required to obtain this sort of functionality by closely coupling the finite state machine with each processor in the array.

In some instances, each finite state machine 508a-d is configured with a set of sub-routines that adaptively execute dependent on a corresponding set of data stored within the corresponding processor 506a-d. In this instance, much like in MIMD, each processor 506a-d can be executing a different operation at any given time; however, these operations are determined by a constrained set of operations stored inside of the FSM set at design time or reconfigured in a preparation step before the data is distributed.

In some instances, the global instruction 502 functions as a SIMD frontend for a higher-level device to begin a particular workload and give global execution hints, but the FSM 508a-d converts this global instruction 502 into a data-dependent control flow to enable more execution flexibility. The FSM 508a-d performs the conversion by decoding the global instruction 502 into a set of instructions using an operations selector.

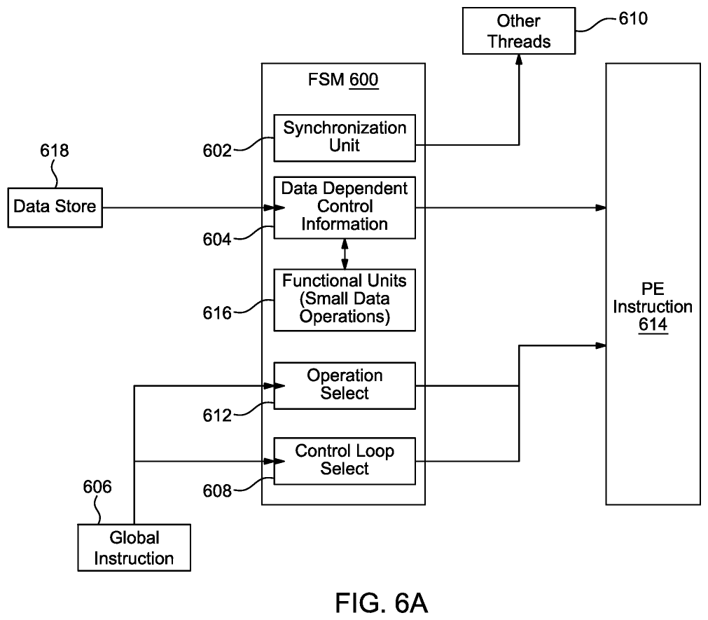

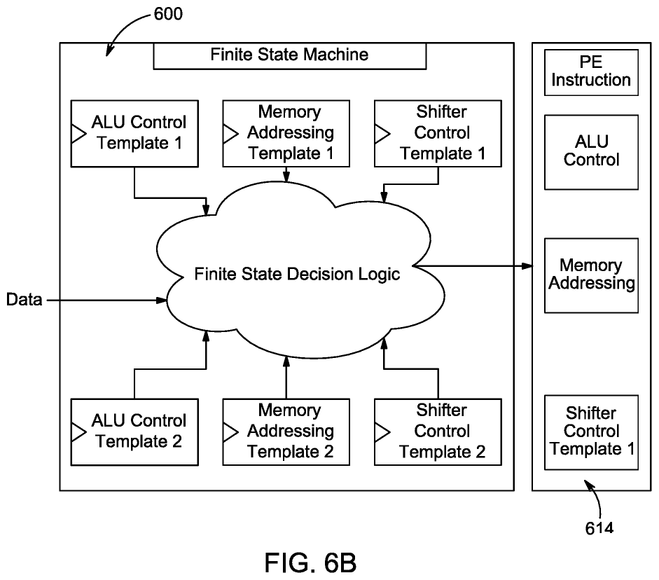

FIG. 6A illustrates an example of an FSM 600 that is utilized in some example implementations. For example, FSM 600 can be used to orchestrate data-dependent control flow. The FSM 600 selects and outputs an operation 614 that is executed by a respective processor such as processors 506a-d.

In some instances, a synchronization unit 602 may manage the synchronization of the processor 506 control flow with another processor, in the single global instruction with finite state machine processor 500. The synchronization unit is implemented as a circuit which could be embodied in a number of ways (e.g., locks or barriers). In other instances, the synchronization unit 602 allows for synchronization between threads without explicit synchronization barriers. For example, in one particular implementation, the synchronization unit includes a collaboration network through which a processor performs a spin-lock or handshake operation to acknowledge one of the other processors.

In some instances, each FSM 600 stores some amount of data-dependent control information 604 which the FSM 600 alters to create a data-dependent control loop 604. A data-dependent control loop is a loop in which the control of the thread is dependent on the content of the data. In a traditional control loop, the number of iterations and the sequence of operations are fixed and predetermined. However, in a data-dependent control loop, the loop's behavior is determined based on the data being processed or the conditions evaluated during runtime. This enables the program to adapt its behavior according to the specific requirements or characteristics of the data.

In these instances, the FSM 600 utilizes the global instruction 606 to determine which of these data-dependent control loops 604 to execute via a control loop select 608. In this context, the global instruction 606 is an instruction dispatched from the SIMD instruction frontend to each thread. The loop would be selected based on a field from the global instruction 606.

In many instances, the field is a subset of the instruction. Typically, this is expressed as a subset of the total number of bits in the instruction. For example, a 32-bit instruction may have a “field” that is represented by a subset of those bits. Accordingly, bits 27:20 (inclusive) would identify an 8-bit field.

In many instances. the instruction frontend is an instruction dispatch unit or control core. This the instruction frontend is responsible for managing the instruction dispatch to an entire device such as Single Global Instruction with Finite State Machine processor 500. In effect, the instruction frontend operates like a “manager” which delegates work to the individual processing elements (such as 506a-d).

Accordingly, in some instances, with a combination of the global instruction 606 and the data-dependent control information 604, each thread is capable of executing its own independent control loop while conforming to a global instruction 606. In other words, in some instances, a global instruction 606 has an associated control loop that can be traversed independently by different threads. In such instances, although each thread is considered to be executing the same global instruction at any particular time, in accordance with SIMD, it is possible for one or more such threads to be at a different location in the control loop that is associated with the global instruction. Further, the location in the control loop at which a particular thread is at is determined based on the data processed by that thread.

In some instances, during the execution of this control loop, an FSM 600 may choose to collaborate or join with another FSM which has completed its data-dependent control loop 604 to combine information. For example, two threads may synchronize and progress towards the next stage of the global goal before other threads 610 have finished the first stage.

In some instances, the FSM 600 retrieves data from the data store 618. The data store 618 comprises a register file or other data storage mechanism and is local to a particular thread as is the FSM 600. The data store 618 contains the data pertinent to selecting a particular operation out of the operations appropriate for a global instruction. In an example, with sparse linear algebra SpMV calculations, this data is the number of non-zero elements in a particular row that dictates how many instructions should be generated to calculate the output for that row. Thus, in some such examples, this information dictates whether a particular thread is looping through the operations for performing SpMV calculations or has terminated such operations (e.g., because the thread has completed such operations for the non-zero elements).

In some examples, the FSM 600 also contains an operation select function 612. This selects, based on the global instruction 606, an operation that is performed by the individual thread (e.g., a multiply or add operation). In some examples, the operation select function 612 selects the operation based on the global instruction 606, the information in the data store 618, and, optionally data being processed by the thread. The operation performed by the thread can differ by application, even when the control loop is the same. For example, the operations may vary between graph and sparse linear algebra applications even when they utilize the same control flow.

In some examples, functional units 616 are included in the FSM 600. The functional units 616 are generalized as workload-dependent units which can perform useful operations. Specifically, the functional units 616 may derive information from the data in data store 618 that will be utilized in the creation of a control loop. In some examples, the functional units 616 are implemented as combinations of logic gates.

The FIG. 6B shows an example of a finite state machine 600. In this example embodiment, the data is input into the processor from its memory and the control templates are provided by a global instruction dispatch. In many instances, the control template is a field in the instruction which is “decoded” and is then used to provide control signals to an individual thread.

The control templates are generalized as information coming from the global instruction which can be applied to the formulation of an instruction. The control templates are used to allow more configurability to the FSM's control loop which may need to be dynamic. The global instruction dispatch is stored inside of “template” registers inside of each individual core which are then operated on via the Finite State Decision Logic, or the state transitions typical of an FSM. This execution flow allows for devices to adapt which operations are being executed by the static Finite State Machine.

In an example, the global instruction replaces the ALU template 1 with a multiply operation, and then when the Finite State Machine selects Control template 1, the processor will be instructed to perform a multiply on the data.

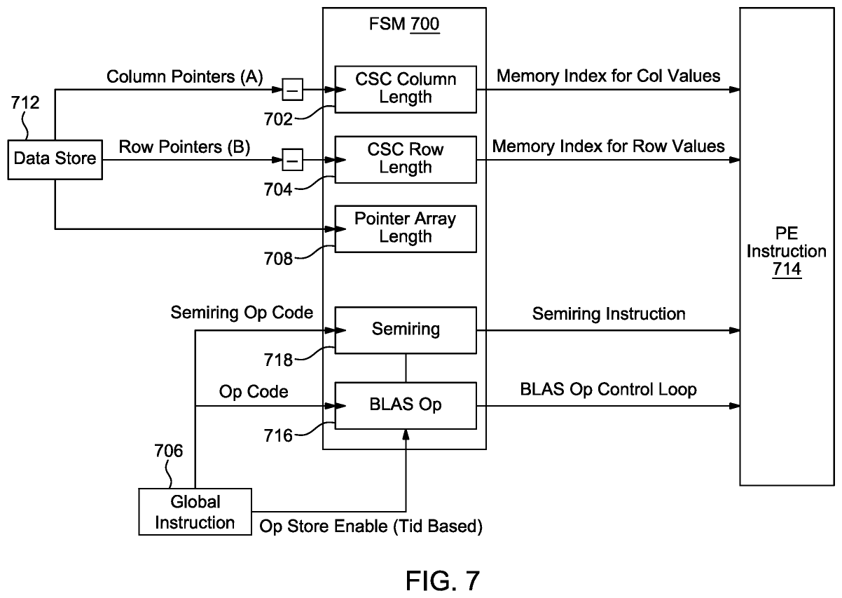

An example of Finite State Machine for Sparse Linear Algebra 700 is illustrated in FIG. 7. In this example, the FSM 700 provides instruction 714 for a processor to apply a particular mathematical operation (e.g. semiring) to the data in its local data store 712. In some instances, the FSM 700 merges the control flow (signaled by the global instruction 706) and the data flow (signals the structure of the data) to create a modified control flow based on the structure of the data.

In some instances, the FSM 700 includes several registers that are stored within the FSM 700. For example, the FSM may include:

CSC Column Length Register 702, which stores the length of the NNZ in the current column (“A”). Column “A” represents any column in the matrix. Accordingly, “A” can be interpreted as a variable, in which the variable can represent any column number in the matrix. Length in this context is the length of a column in a sparse matrix. The length of a column is metadata provided with a dataset which is compressed in CSC format.

CSR Row Length Register 704, which stores the length of the NNZ in the current row (“B”). Column “B” represents any column in the matrix that is different that Colum “A”. Accordingly, “B” can be interpreted as a variable, in which the variable can represent any column number in the matrix.

Pointer Array Length Register 708, which stores the length of the pointer array. The pointer array stores pointers that are pointing to the beginning of the columns. The length of the column is variable, so it's important to keep the pointers to know where one column starts and the next begins. By knowing the length of the column, the number of times required to increment the address to access a different column can be determined. The length of the array is defined by the number of columns assigned to a processor such as processor 506a-d. The Row length similarly may store the length of a row in matrix B for the same reasons but replace column with row. For example, in the case of a vector, the length of the row of B is one.

Semiring Register 718, which stores the semiring (e.g., add/sub/mul/min/sel) which should be applied to the data. A semiring is a mathematical structure that combines properties of both rings and semigroups. It is defined as a set equipped with two binary operations, typically denoted as addition (+) and multiplication (·), satisfying a set of axioms. A semiring is a generalization of a ring where the requirement of additive inverses (negatives) is relaxed.

BLAS op Register 716, which stores the Basic Linear Algebra Subprograms (BLAS) operation which is taking place (SPMM, SPMV, E-Wise Mul, etc.) BLAS are a collection of low-level routines for performing basic vector and matrix operations efficiently. BLAS provide standardized interfaces for operations such as vector addition, vector scaling, dot products, matrix-vector multiplication, matrix-matrix multiplication, and other linear algebraic computations.

In some examples, the global instructions is Tid based, whereby each thread has a Thread ID (“tid”) that represents the entries it needs to access from the global instructions to perform its particular operations.

In some instances, the FSM 700 uses pointers to the data store 712 to generate the memory addresses. For example, the FSM 700 may generate addresses conditionally based on the metadata of the sparse matrix. In the sparse example, it is necessary to know which column you are in in relation to the vector you should multiply the values by. For example, matrix column A must be multiplied by the vector value in row A and matrix column B must be multiplied by the vector value in row B.

However, these calculations become more problematic when the values are in memory, and there is no clear indication of what each of the values are representing. In order to perform these operations under these conditions it becomes necessary to know where “column A” ends and begins so that the memory location represents column A can be determined. In this exact example, the FSM 700 will store information that will allow it to deduce the start location of Column A from some metadata. And then building on that deduction it can further deduce the start location of column B from the start location and length of column A. By doing this, the FSM 700 may begin to generate addresses based on this knowledge of the structure of column A and column B.

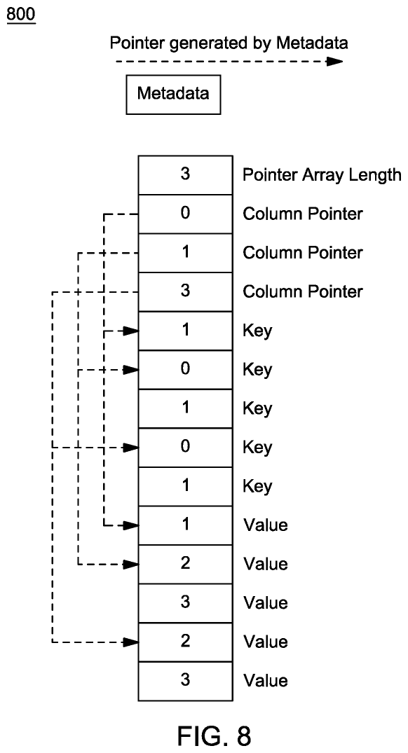

FIG. 8 illustrates an example of a Compressed Sparse Column (CSC) Compressed Matrix 800. In this example, the Finite State Machine for Sparse Linear Algebra 700 may be used in isolation to determine the length of the sequences (the two columns, and the vector) and instruct the thread to multiply the matrix values with the vector values. The control flow is dependent on the data due to the sparsity of the matrix introducing dynamism in the control flow and will cause thread divergence due to the inherent load imbalance characteristics inherent to this workload. When the Finite State Machine for Sparse Linear Algebra 700 has completed its operations and reduced its own values, it then opportunistically communicates with other threads running in different Finite State Machine for Sparse Linear Algebra 700 to further reduce the set of partial products. This results in an overall reduced latency for the group of threads to complete its operation.

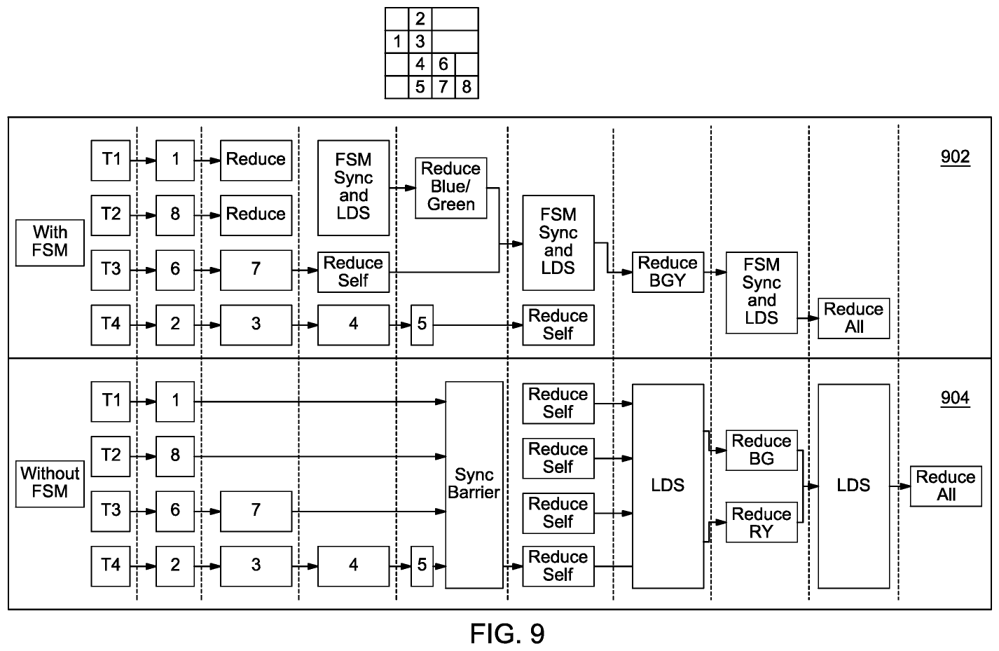

FIG. 9 illustrates a comparison of an example FSM dataflow 902 and non-FSM dataflow 904. For example, the FSM dataflow 902 may be utilized by the Single Global Instruction with Finite State Machine processor 500. The non-FSM dataflow 904 may be utilized by the conventional array scale SIMD machine 300. FIG. 9 shows how the Finite State Machine 600/700 enables individual threads to reduce their partial products asynchronously from the rest of the SIMD cores. This may enable the kernel for this sparse matrix to finish the operation in fewer time steps.

For example, when a SpMV operation is applied to a sparse matrix where the amount of work for each column is dependent on the sparsity of the column. If each column is allocated to a thread, then there will inherently be thread divergence in the execution of the operation, as the number of values and operations required experience significant dynamism. Aspects of the present disclosure allow a tolerance of this divergence while being able to switch to a reduction of the values between individual threads, which complete before all other threads are completed.

Particularly, in large SIMD structures, such as those with thousands of processors, aspects of embodiments allow for significantly less control complexity with an overhead of less than 1% of a thread. At a conceptual level, this tolerance of divergence allows individual threads to perform multiple operations at a sub-compute unit (CU) level, which are divergent from the other threads in the CU and synchronize individually with other threads to perform collaborative operations at a smaller granularity than a full CU.

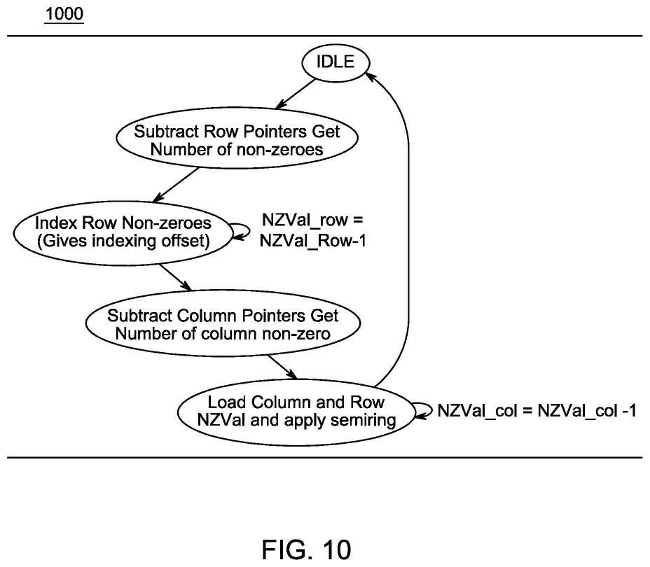

FIG. 10 depicts an example of a Sparse Linear Algebra Control Flow in accordance with aspects of an embodiment. Specifically, FIG. 10 shows a Finite State Machine 1000 for applying a semiring to a row and column pair for linear algebra operations. For sparse linear algebra, the number of values in a column and row are determined by pointers which, when subtracted, determine the number of non-zero elements in a column and row.

In some instances, the Finite State Machine 1000 may be used to index the row values and iterate over the column values. Through creating multiple “sub-routines,” the Finite State Machine 1000 may map to additional algorithms relevant to the workload of interest. Generally, these subroutines will map to algorithms which will branch from the waiting state of the Finite State Machine 1000 in order to perform additional useful computations such as sorting or ordering of data before collaboration with another thread.

By adding a Finite State Machine to the conventional SIMD processing array, in accordance with aspects of an embodiment, the resulting processing array becomes tolerant to some divergence without explicit fine-grained synchronization. This is beneficial in workloads such as sparse linear algebra, where much of the control flow is determined by the sparsity and shape of the input matrix. This processing array may reduce the number of synchronization barriers and spin loops required to handle divergence between threads within a single SIMD unit. In addition to what is essentially a thread-to-thread network, it is possible to create an architecture that is tolerant of data-dependent execution flows and able to synchronize between threads to continue forward progress without stalling for the slowest thread. This is especially useful in sparse linear algebra as it allows overlapping SpMV multiply and reduction phases on a single large SIMD array.

Another method of orchestrating this data-dependent control flow and process synchronization between threads is by using controller CPUs. However, through synthesis, the overhead of the Finite State Machine was determined to be significantly lower than the size of an individual controller CPU. Accordingly, this approach can be further generalized for use with common workloads which have thread divergence and require explicit synchronization between several threads in the same block, as the FSM will allow for synchronization between the faster threads without waiting for the slowest thread in the block.

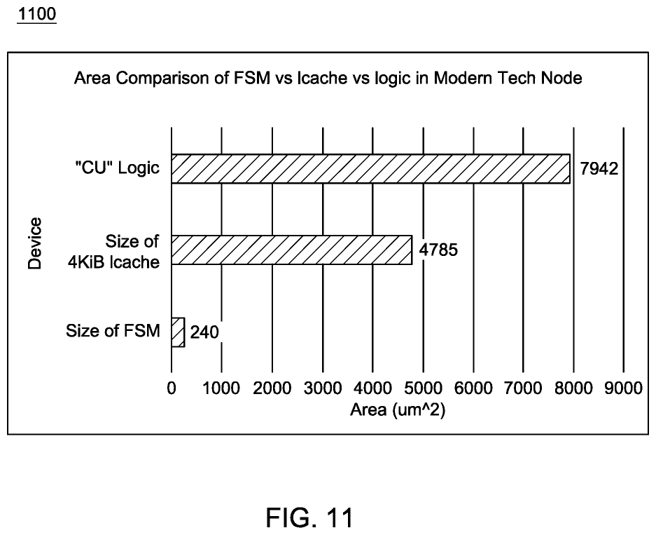

Plot 1100 in FIG. 11 shows a comparison of the area of a conventional “CU” core, a 4KiB iCache, and the size of the FSM in accordance with aspects of an embodiment. These results were obtained through the synthesis of a “CU” logic, iCache, and Finite State Machine in equivalent technology nodes utilizing a synthesis flow. As shown in FIG. 11, the area of the finite state machine is 5% of that of the 4 KiB instruction cache. Considering that in a many thousand processor SIMD array, there will be many thousands of these threads, implementations of aspects of an embodiment may result in a substantial overall area reduction in comparison to incorporating a controller CPU and an iCache to provide the same functionality to a limited number of workloads.

In order to add MIMD capability to a device in addition to a controller CPU, it will require storage of instructions that can be independently looped through at a thread level. However, the overhead of adding an instruction cache to each thread is very high. While the instruction cache may provide more flexibility by allowing different instructions to be stored in each thread, this is not necessary to support a limited set of specific workloads.

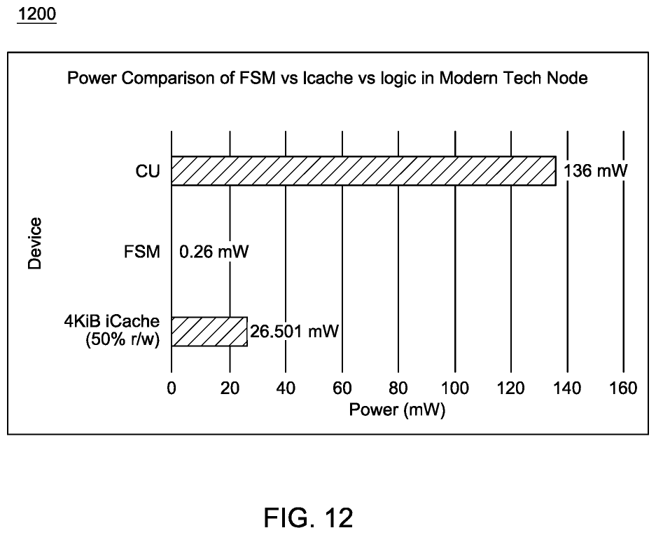

FIG. 12 shows a plot 1200 of the comparison of power consumption between the Finite State Machine in accordance with embodiments, compute logic, and a 4KiB iCache. It is shown that the FSM consumes 1% of the amount of power that is consumed by the iCache. With this benefit spread over thousands of SIMD cores, the power savings may a significant improvement in the overall power consumption of the device.

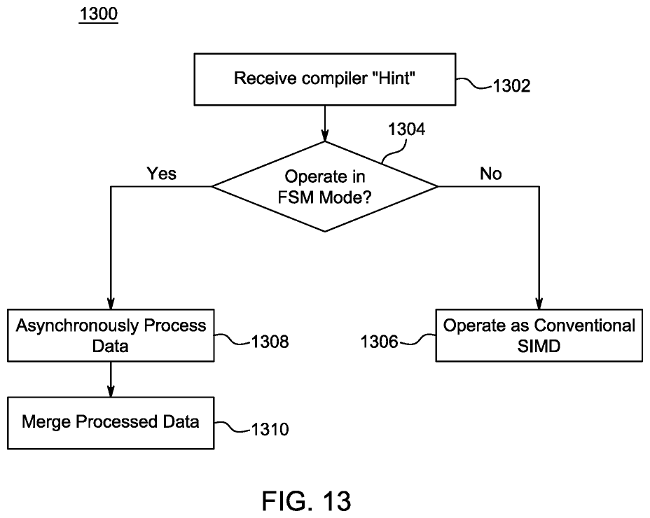

FIG. 13 shows an example process 1300 for implementing aspects which would be implemented by a particular thread. In step 1302, the “Hint” (i.e., compiler hint or compiler directive) is received. Then based on the hint the system determines whether to operate in FSM mode (1304). If in step 1304, it is determined to not operate in FSM mode, the system proceeds to operate as a conventional SIMD in step 1306.

Otherwise, if at step 1304, it is determined to enter FSM mode, the system proceeds to process the data asynchronously in step 1308. In step 1308, the data is processed using an FSM. In some instances, the FSM is configured to perform Semiring operations.

Then in step 1310, the asynchronously processed data that is generated by one processing unit is merged with the asynchronously processed data that is generated by another processing unit. The merging of the data occurs through the collaborative network discussed previously. Each thread may asynchronously signal that its processing is complete and proceed to search for other signaling threads that are available to merge data with via the collaborative network. The data is merged through a shared memory.

Each of the units (including the Single Global Instruction with Finite State Machine processor 500, the FSM 600 and FSM 700) illustrated in the figures represents hardware circuitry configured to perform the operations described herein, software configured to perform the operations described herein, or a combination of software and hardware configured to perform the steps described herein.

It should be understood that many variations are possible based on the disclosure herein. Although features and elements are described above in particular combinations, each feature or element can be used alone without the other features and elements or in various combinations with or without other features and elements.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A processing array comprising:
a plurality of processors; and
a plurality of finite state machines, wherein each respective finite state machine among the plurality of finite state machines is communicatively coupled to a respective processor among the plurality of processors,
wherein each respective plurality of processors is configured to selectively utilize the respective finite state machine in processing of data.

2. The processing array of claim 1, wherein the plurality of finite state machines implement sparse linear algebra operations.

3. The processing array of claim 1, wherein each respective processor among the plurality of processors is configured to selectively utilize the respective finite state machine in processing data based on a hint that is included in global instruction that is received by the processing array.

4. The processing array of claim 3, wherein the hint causes a subset of the plurality of processors to utilize the respective finite state machine in processing of the data.

5. The processing array of claim 4, wherein the subset processes the data asynchronously with respect to a remainder of the plurality of processors not included in the subset.

6. The processing array of claim 1, wherein each respective processor among the plurality of processors is further configured to merge results of processing the data with one or more other processors among the plurality of processors.

7. A method for processing data, the method comprising:
receiving, by a processing array, a request to process the data, wherein the processing array includes a plurality of processors;
in response to the request containing a hint, configuring a respective processor among the plurality of processors to utilize a respective finite state machine of the respective processor; and
processing the data using the respective finite state machine.

8. The method of claim 7, wherein the respective finite state machine implements sparse linear algebra operations.

9. The method of claim 7, wherein the request is included in global instruction.

10. The method of claim 7, wherein the hint causes a subset of the plurality of processors to utilize the respective finite state machine in the processing of the data.

11. The method of claim 10, wherein the subset processes the data asynchronously with respect to a remainder of the plurality of processors not included in the subset.

12. The method of claim 11, further comprising:
merging results of processing the data with one or more other processors among the plurality of processors.

13. A non-transitory computer readable storage medium, storing instructions for processing data, the instructions when executed by a processing array, cause the processing array to execute a method that includes:
receiving, by the processing array, a request to process the data, wherein the processing array includes a plurality of processors;
in response to the request containing a hint, configuring a respective processor among the plurality of processors to utilize a respective finite state machine of the respective processor; and
processing the data using the respective finite state machine.

14. The non-transitory computer readable storage medium of claim 13, wherein the respective finite state machine implements sparse linear algebra operations.

15. The non-transitory computer readable storage medium of claim 13, wherein the request is included in global instruction.

16. The non-transitory computer readable storage medium of claim 13, wherein the hint causes a subset of the plurality of processors to utilize the respective finite state machine in the processing of the data.

17. The non-transitory computer readable storage medium of claim 16, wherein the subset processes the data asynchronously with respect to a remainder of the plurality of processors not included in the subset.

18. The non-transitory computer readable storage medium of claim 17, wherein the method further comprises:
merging results of processing the data with one or more other processors among the plurality of processors.
